(19) United States
(12) Patent Application Publication
(10) Pub. No.: US 2021/0041137 A1
(43) Pub. Date: Feb. 11, 2021

(54) METHOD AND SYSTEM FOR DETECTING BLOCKAGES IN CONDENSATE LINES AND NOTIFYING INTERESTED PARTIES

(71) Applicant: Joseph G. Collins, Boca Raton, FL (US)

(72) Inventor: Joseph G. Collins, Boca Raton, FL (US)

(21) Appl. No.: 16/989,094

(22) Filed: Aug. 10, 2020

Related U.S. Application Data
(60) Provisional application No. 62/884,746, filed on Aug. 9, 2019.

(51) Int. Cl. F24F 13/22; F24F 11/32; F24F 11/56; G01F 23/16

(52) U.S. Cl. CPC F24F 13/222; F24F 11/32; F24F 2013/228; G01F 23/161; F24F 11/56

(57) ABSTRACT

A heating, ventilation and air conditioning (HVAC) system, fluid level sensor and method of detecting and resolving condensate line blockages are provided. A plurality of sensor probes are attached to a drain system of an HVAC system such that each probe detects a different level of fluid. Responsive to determining that the sensor probe is contacting fluid, an action of a hierarchy of actions is initiated, wherein each action is associated with one of the sensor probes of the plurality of sensor probes. Repeating the determining and initiating steps for each sensor probe of the plurality of sensor probes until all actions in the hierarchy of actions have been initiated sequentially.

### CROSS-REFERENCE TO RELATED APPLICATIONS

This application is based upon and claims priority from prior U.S. Provisional Patent Application No. 62/884,746, filed on Aug. 9, 2019 and entitled, “Method for Detecting Blockages in Condensate Lines and Notifying Interested Parties,” the disclosure of which is herein incorporated by reference in its entirety.

### BACKGROUND

### Technical Field

The present disclosure generally relates to condensate lines and more specifically to detecting and removing blockages and notifying appropriate personnel concerning blockages in condensate lines used in heating, ventilation and air conditioning (HVAC) systems.

### Description of the Related Arts

Condensation drain lines are used to remove excess water (i.e. condensate) produced in HVAC systems. These drain lines are generally cleared naturally by gravity, or through the use of condensate pumps to pump the condensate out. Condensation drain lines, however, are prone to developing blockages that lead to unscheduled downtime of the HVAC systems and even property damage.

Currently there are devices that monitor condensation line fluid levels and will disable the system generating the condensation before an overflow occurs. Generally, an HVAC system is equipped with a drain pan that collects condensation that forms from the HVAC unit. As the drain pan fills, the condensate is routed through a drain line and away from the unit. Over time, materials deposited within the condensate, such as dust or biological materials, collect within the condensate drain line, creating small blockages in the drain line as particles are deposited on the lines as they pass through. As the blockages become larger, the amount of water/condensate collecting in the drain pan takes a longer time to empty until the water typically reaches a high enough level to activate a mechanical float switch or other sensor which disables the system. These current approaches that detect such blockages do not provide preemptive measures to correct or alleviate the problem before the blockage becomes serious. Consequently, the interested party only becomes aware of a problem when it has reached a critical level such that the system has to be deactivated to prevent overflow that could result in property damage.

Users of condensation-generating systems are dependent on these systems remaining operational for various reasons including health, quality of life and business continuity. In hot climates a small disruption of service can lead to major inconveniences. Given that the current devices are passive and do not provide preemptive measures to prevent an impending issue, users are unable to remedy a blockage before it escalates such that a disruption of service is unavoidable. Consequently, users experience unplanned service interruptions coupled with costly emergency maintenance.

Therefore, there is a need for a method for detecting and correcting blockages in condensate lines prior to shutting down the system.

### BRIEF SUMMARY

In one embodiment, a method for progressively detecting, correcting, and notifying an interested party of a condensate line blockage in an HVAC system is disclosed. The method comprises attaching a plurality of sensor probes to a drain system of a heating, ventilation and air conditioning (HVAC) system such that each probe detects a different level of fluid; determining whether a sensor probe of the plurality of sensor probes is contacting fluid; responsive to determining that the sensor probe is contacting fluid, initiating an action of a hierarchy of actions, wherein each action is associated with one of the sensor probes of the plurality of sensor probes; and repeating the determining and initiating steps for each sensor probe of the plurality of sensor probes until all actions in the hierarchy of actions have been initiated sequentially.

In another embodiment, a fluid level sensor for use in detecting and resolving condensate line blockages in an HVAC system is disclosed. The fluid level sensor comprises a housing, a mounting block slidingly attached to the housing for mounting the fluid level sensor to an HVAC draining system, and a plurality of sensor probes arranged in the housing such that each probe is configured to detect a different level of fluid when the housing is attached to the draining system.

In yet another embodiment, a heating, ventilation and air conditioning (HVAC) system is disclosed. The HVAC system comprises a condensate resolving system coupled to an electronic control unit. The condensate resolving system detects and resolves condensate line blockages. The condensate resolving system comprises a draining system and a fluid level sensor. The draining system has a drain pan and/or a condensate line. The fluid level sensor contains a plurality of sensor probes arranged such that each probe is configured to detect a different level of fluid when the fluid level sensor is attached to the draining system. The electronic control unit is configured to: determine whether a sensor probe of the plurality of sensor probes is contacting fluid; and responsive to determining that the sensor probe is contacting fluid, initiate an action of a hierarchy of actions, wherein each action is associated with one of the sensor probes of the plurality of sensor probes.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment comprising a condensate line blockage detecting system used in an HVAC system according to one embodiment of the present invention;

FIG. 2 is a block diagram of one example of the electrical control unit (ECU) used in the HVAC system of FIG. 1 in accordance with one embodiment of the present invention;

FIG. 3 is an operational flow diagram illustrating a flow chart for a process of detecting and correcting blockages in condensate lines according to one embodiment of the present invention;

FIG. 4 is a front view of an example Fluid Level Sensor (FLS) according to one embodiment of the present invention;

FIG. 5 is a perspective view illustrating a back side of the FLS of FIG. 4 according to an embodiment of the present invention;

FIG. 6 is a perspective view of an example mounting bracket for use with the FLS of FIG. 4 which a tightening screw mounting mechanism according to an embodiment of the present invention;

FIG. 7 is a perspective view of another example mounting bracket for use with the FLS of FIG. 4 which uses a magnetic mounting mechanism according to an embodiment of the present invention;

FIG. 8 is a perspective view of yet another example mounting bracket for use with the FLS of FIG. 4 which uses a spring mounting mechanism according to an embodiment of the present invention;

FIG. 9 is a perspective view of an alternative mounting mechanism for use with the FLS of FIG. 4, wherein the mounting mechanism is built into the primary condensate lines according to another embodiment of the present invention;

FIG. 10 is a front view illustration of the FLS of FIG. 4 connected to the ECU of FIG. 3 in accordance with an embodiment of the present invention; and

FIG. 11 is an operational flow diagram illustrating a flow chart for a simplified process of detecting and correcting blockages in condensate lines according to one embodiment of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In this disclosure, a method is provided for detecting and correcting condensate line blockages. Although the method is described in relation to operation of heating, ventilation and air conditioning (HVAC) systems, it should be noted that the methods and devices disclosed herein may be used with any type of system that needs to detect rising levels of fluids due to condensate line blockages and correct this condition. In addition, although one embodiment of an HVAC system is discussed in detail, many other configurations of HVAC systems may be used with the present invention. The description is not to be taken in a limiting sense but is made merely for the purpose of illustrating the general principles of the present invention. It should be further noted that the terms “water,” “fluid,” and “condensate” are used interchangeably herein.

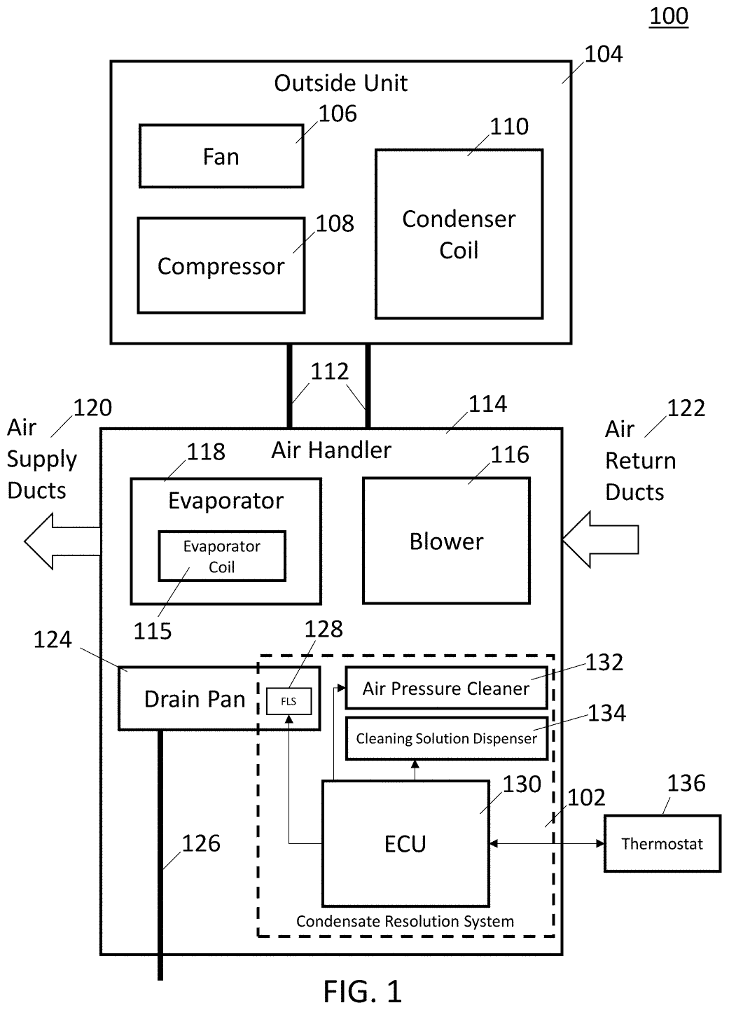

Turning now to FIG. 1, an example HVAC system 100 includes a condensate resolution system 102 to prevent water or other fluid overflow. The HVAC system 100 further includes an outdoor unit 104 which contains a fan 106, a compressor 108 and a condenser coil 110. The outdoor unit 104 operates in a manner known in the arts. Cool, gaseous refrigerant is returned/pumped from an air handler 114 to the outdoor unit 104 via tubing 112. Compressor 108 then compresses the cooled refrigerant, forming a superheated gas. That superheated gas is circulated through the condenser coil 110, condensing it into a liquid. The heat removed from the superheated gaseous refrigerant is rejected to the atmosphere by fan 106. The condensed liquid refrigerant is pumped back to the air handler 114.

The air handler includes a blower 116 and an evaporator 118. The cooled refrigerant flows through an evaporator coil 115 in the evaporator 118 where it is evaporated into a gas. A blower 116 blows air over the evaporator coil which has cooled refrigerant running through its tubing, thereby cooling the air as the air passes over. The cooled air circulates through an enclosed space (e.g., room, office, building, home, etc.) via air supply ducts 120 and warmer air is returned to the air handler 114 via air return ducts 122, to be recirculated over the evaporator coil by the blower 116.

As warm air passes over the evaporator coil, humidity from the air condenses on the coil due to the colder refrigerant flowing through the coil and forms condensate. Excess condensate falls to a drain pan 124 and typically is expelled from the HVAC system 100 via a condensate drain line 126. However, as time goes on, the condensate within the drain pan 124 is prone to collect impurities such as bacteria, algae, sediments, or other debris that tend to build up in the condensate drain line 126 and form blockages. When a line 126 is blocked, water collects in the drain pan 124. It should be noted that the condensate drain line 126 does not have to be completely blocked for fluid to begin collecting in the drain pan 124. A partial blockage may also slow the flow of the fluid enough to cause accumulation.

The condensate resolution system 102 detects rising levels of water via a novel fluid level sensor (FLS) 128. In an embodiment, the FLS 128 is mounted on the side of the drain pan 124 to detect rising water levels. The FLS 128 contains a plurality of sensors that are arranged such that each sensor activates at a different level of water. Each sensor could employ a float switch-triggered potentiometer, including a solid-state device with no moving parts (capacitive, resistive, etc.), which will be more reliable, smaller and cheaper to manufacture. Alternate sensors may include an ultrasonic system to detect the level of the fluid using sound waves.

The FLS 128 is connected to an electronic control unit (ECU) 130 which controls the actions of the condensate resolution system 102. Each sensor of the FLS 128 is connected to an input pin of an I/O interface on the ECU 130. The electronic control unit 130 monitors an analog electrical signal from each sensor on the input pins via analog-to-digital converters (ADCs).

As sensors are triggered, the ECU 130 determines what action will be taken depending upon what sensor has been triggered and the prior states of each sensor. For example, the ECU 130 may proceed through a programmable hierarchy of actions to reduce the amount of condensate in the drain pan 124. When water reaches a first level, the ECU 130 may, for example, activate a cleaning solution dispenser 132 to release a certain level of cleaning solution into the pan to break up the blockage. If the first action is unsuccessful, a second sensor will trigger as the water level rises. In response, the ECU 130 will trigger a second action, such as increasing the amount of cleaning solution dispensed or activating an air pressure cleaning system 134 to blow pressurized air through the condensate line 126 to clean out the blockage.

The ECU 130 follows a programmable hierarchy of actions to conduct as the sensors in the FLS 128 are triggered. These actions may include, but are not limited to:
Releasing predetermined amounts of cleaning solution into the drain pan
Activating an air pressure system to blow out the condensate line
Notifying the user (e.g., owner, maintenance company, serviceman, or third-party property management) concerning the blockage via email, text message, phone call, machine-readable message or file
Activating a backup system
Powering off the HVAC system

The order of the actions is configurable by the end-user or service technician. Setting the order of actions associates each action with a specific sensor pin. It should be noted that notifying a user may comprise sending a notification (e.g., Short Message Service (SMS) text, push notification, email, etc.) to a software package or application.

As the water level continues to rise, the actions taken by the condensate resolution system 102 become increasingly aggressive until the ECU 130 finally powers off the HVAC system 100 to prevent water damage to the surrounding environment. It should be noted that the actions are executed in sequential order to take preventative action before the fluid levels are critical, such that the HVAC needs to be shut down.

In one embodiment, the ECU 130 may also control the operation of the HVAC system 100. The ECU 130 may be built into a main control system (not shown) to control when components of the air handler 114 and the outside unit 104 are turned on and off. The ECU 130 is further in communication with a thermostat 136. Thermostat 136 measures the ambient temperature and sets temperature thresholds via a user interface. Thermostat 136 may also be used to enter the configuration parameters for the condensate resolution system 102.

In another embodiment, the ECU 130 may be a stand-alone unit that is separate from the HVAC system's main controller. In this case, the ECU 130 controls only the actions of the condensate resolution system 102 and is in communication with the rest of the HVAC system 100 only to be able to power off the outdoor unit 104 and the air handler 114 in the event that the condensation resolution system 102 is unable to resolve the condensation line blockage.

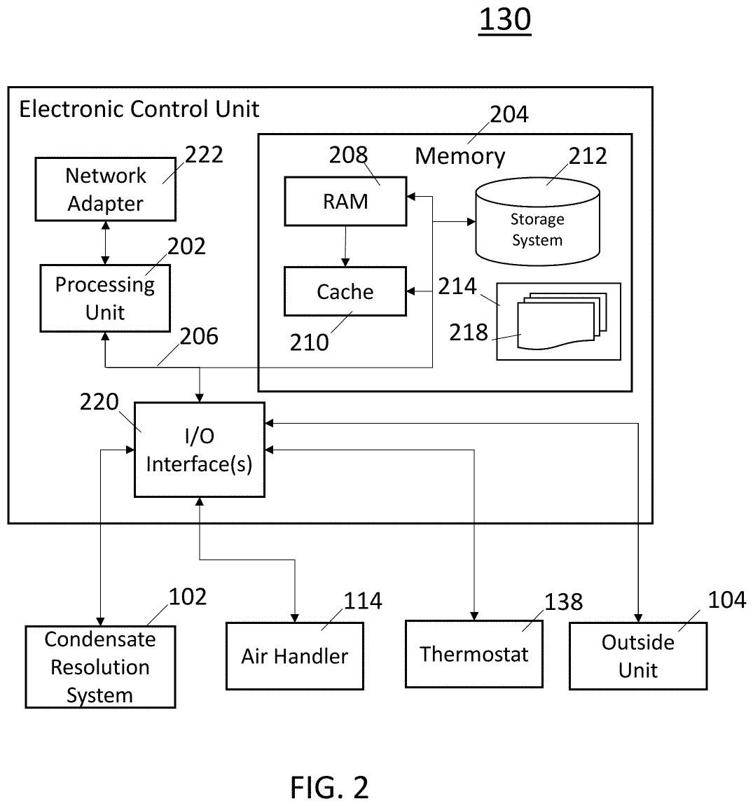

Referring now to FIG. 2, this figure is a block diagram illustrating an electronic control unit 130 that can be utilized in embodiments of the present disclosure. The electronic control unit 130 is based upon a suitably configured processing system configured to implement one or more embodiments of the present disclosure (e.g., condensate resolution system). Any suitably configured processing system can be used as the electronic control unit 130 in embodiments of the present disclosure. The components of the electronic control unit 130 can include, but are not limited to, one or more processors or processing units 202, a system memory 204, and a bus 206 that couples various system components including the system memory 204 to the processor 202.

The bus 206 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 2, the main memory 204 may include a state machine which tracks the current state of all sensors and a hierarchical action list which determines the order of actions to be taken. One or more of these components can reside within the processor 202 or be a separate hardware component. The system memory 204 can also include computer system readable media in the form of volatile memory, such as random-access memory (RAM) 208 and/or cache memory 210. The electronic control unit 130 can further include other removable/non-removable, volatile/non-volatile computer system storage media 212. The memory 606 can include at least one program product having a set of program modules that are configured to carry out the functions of an embodiment of the present disclosure.

Program/utility memory 214, having a set of program modules 216, may be stored in memory 204 by way of example, and not limitation, as well as an operating system, one or more application programs, other program modules, and program data. Each of the operating system, one or more application programs, other program modules, and program data or some combination thereof, may include an implementation of a networking environment. Program modules 216 generally carry out the functions and/or methodologies of embodiments of the present disclosure.

The electronic control unit 130 can also communicate with one or more external devices such as the condensate resolution system 102, the outside unit 104, the air handler 114 and the thermostat 138. The thermostat 138 generally includes a keyboard, a pointing device, a display, etc., that enable a user to interact with the electronic control unit 130 to set, among other things, operating temperature, scheduling, communication preferences, and the action order for the condensate resolution system 102. Such communication can occur via I/O interfaces 220.

Still yet, the electronic control unit 130 can communicate with one or more networks such as a local area network (LAN), a wireless LAN (WLAN), a general wide area network (WAN), and/or a public network (e.g., the Internet) via network adapter 222. As depicted, the network adapter 222 communicates with the other components of electronic control unit 130 via the bus 206. The ECU 130 further collects information about its surroundings including its general location on the planet. The ECU's 130 location, coupled with other dimensions (such as the age, model and installation date of the HVAC system 100), may be used to create a statistical model where, geographically, condensation is a known problem, resulting in a predictive analytics-based solution. For example, if the ECU 130 is located in South Florida and the HVAC system 100 was made during the last 3 years, one model might predict that there is an 88% chance of experiencing a blockage in the next 8 months.

Other hardware and/or software components can also be used in conjunction with the electronic control unit 130.

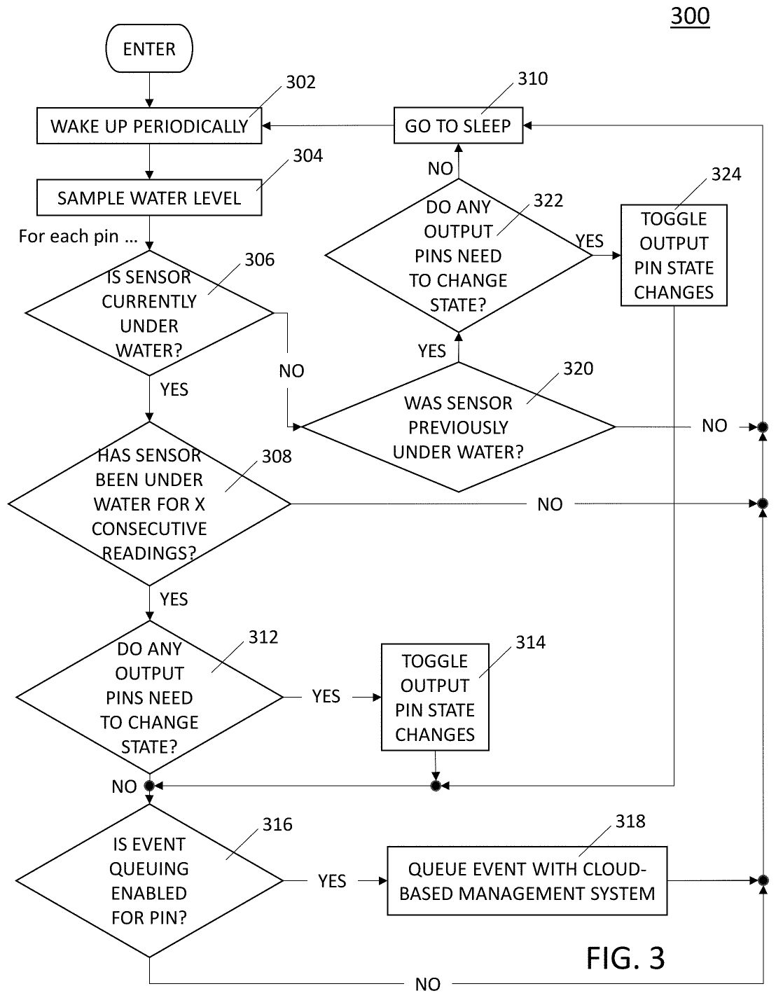

Referring now to FIG. 3, an operational flow chart is provided that describes the steps for a method of detecting and correcting condensation line blockages in accordance with one embodiment of the present invention. Beginning at step 302, the electronic control unit 130 periodically wakes up and samples the water level, at step 304. The water level is sampled by repeating the following process for each sensor (i.e. input pin). The ECU 130 reads the input pin to determine whether the sensor associated with the pin is currently under water, at step 306, by checking values returned by the ADC. Non-zero values indicate that the sensor is “shorted”, therefore, likely under water. If the sensor is currently under water, the process continues to decision block 308 to determine whether the sensor has been under water for a predetermined number (i.e. “X”) of consecutive readings. If the sensor has not been under water for the predetermined number of consecutive readings, the process returns to sleep at step 310. Requiring a predetermined number of consecutive readings helps to prevent false positives. Otherwise, if the sensor has been under water for the predetermined number of consecutive readings, the process continues, at step 312, by checking to see if any output pins need to change state, and if so, toggles any needed output pin state changes, at step 314. Toggling the output pin state activates actions associated with the output pin, such as activating a cleaning solution dispenser, activating an air pressure system to flush the condensate lines, automatically notifying technical personnel or the owner about the blockage, powering down the system, etc. The order of the action is determined by which input pin is changing states and is configurable by the owner or service technician.

After the output pin has been toggled to implement some corrective action, if event queuing is enabled for that input pin, at step 316, then the ECU 130 contacts a cloud-based management system and queues the event, at step 318.

Returning to decision block 306, if the sensor is not currently under water, the ECU 130 determines if the sensor was previously under water, at step 320. If not, then the ECU 130 returns to sleep, at step 310. However, if the sensor was previously under water, the ECU 130 checks to see if any output pins need to change state, and if so, toggles any needed output pin state changes, at step 314. Toggling the output pin state deactivates actions associated with the output pin.

The order of actions associated with each output pin, as well as the number of active sensors, is programmable. For example, a simple home solution may not have every action available as home HVAC systems generally do not have all the components mentioned above (e.g., air pressure system, backup system, etc.) When the condensate reaches a first level, the homeowner is notified and at a second level, the HVAC system is powered off. However, an environment that has a much more stringent need to keep an HAVC system operable, such as a hospital or large-scale computer server facility, may have many more steps in the operation of the condensate resolution system. In this case, the first action may be to engage a cleaning solution dispenser; the second action may be to activate an air pressure system to blow out the lines; the third action may be to notify the building's service department; the fourth action could notify a service maintenance company who is contracted to service the system; the fifth action could switch HVAC operations to a backup system; and the last action would power off the HVAC system.

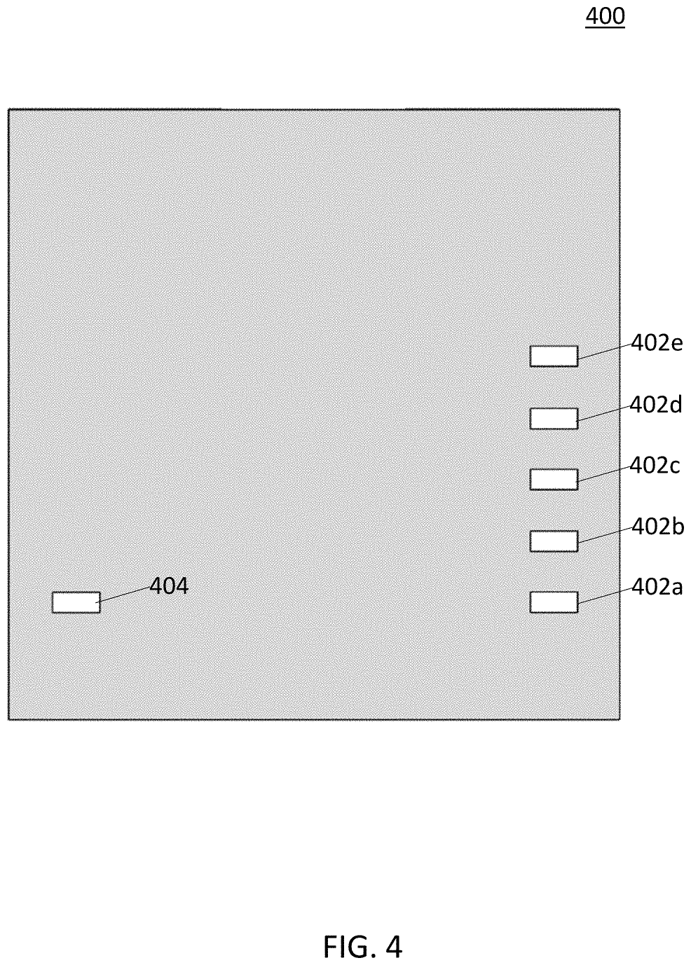

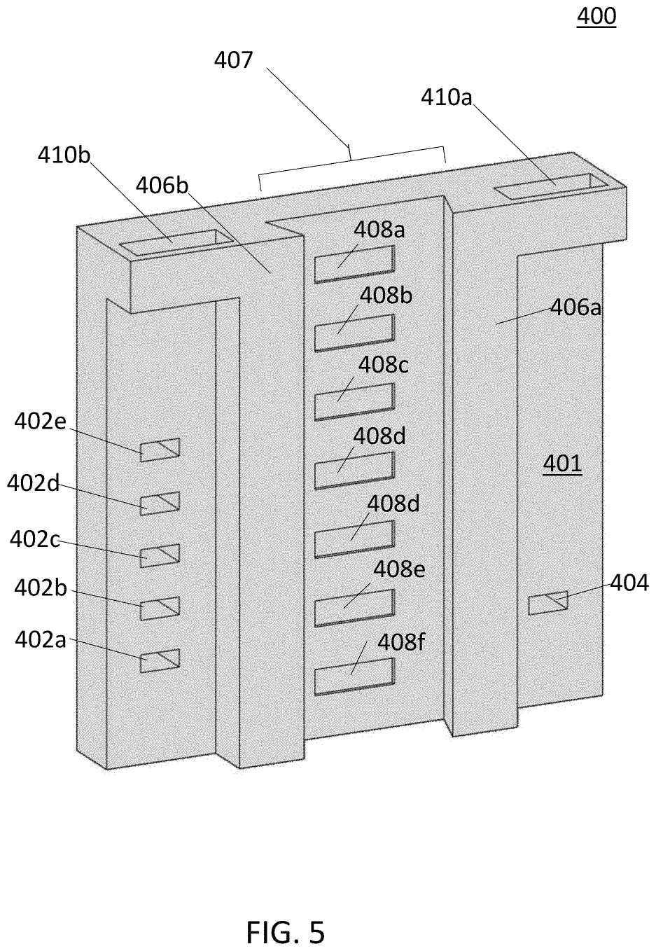

FIG. 4 is an illustration of a front view of an FLS housing 400 in accordance with an embodiment of the present invention. FIG. 5 is a perspective view of the FLS housing 400 showing a rear view. The FLS housing 400 contains a plurality of slots 402a-402e (referenced collectively or generally herein as “slot(s) 402”) into which sensor pins are inserted and attached. The FLS housing 400 is designed to be mounted such that the plurality of slots 402 are stacked vertically such that rising water encounters each pin sequentially. It should be noted that the number of slots 402 shown is not integral to the invention and is shown only for illustrative purposes. Slots 402 may be any size or shape and any number of slots 402 may be used without limiting the invention.

Electricity for the FLS 128 is supplied at slot 404. As slot 404 and slot 402a are at the same height, when the fluid level reaches this height, a small electric current is conducted from the power at slot 404 to the sensor probe in slot 402a. This current effectively “shorts out” the sensor pin in slot 402a. Similarly, as the fluid rises, a small electric current will be passed to the sensor pins in slots 402b-402e in the vertical order of the slots 402.

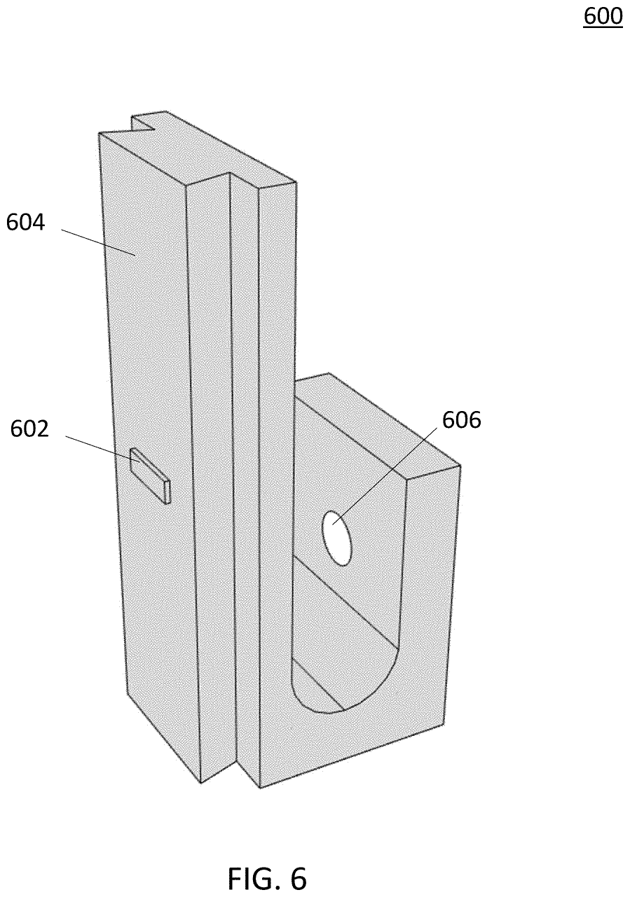

The back side 401 of the FLS housing 400 contains a pair of mounting rails 406a-406b which form a trapezoidal slot 407 which form fits to a mounting block (examples of mounting blocks are shown in FIGS. 6-9) to allow the FLS housing 400 to be attached to a side wall or floor of the drain pan 124, or directly to the primary condensate drain line, external to the drain pan 124. In addition, the FLS housing 400 contains a series of vertical mounting indentations 408a-408f into which a mounting block tab 602 may be inserted to allow for height variation. Openings 410a-410b allow for a wiring harness to be routed through the openings, connecting the sensor pins to the ECU 130.

FIGS. 6-9 illustrate example mounting blocks for use with the FLS housing 400. FIG. 6 illustrates a mounting block 600 with a tightening screw mounting mechanism. The mounting block 600 has a trapezoidal mounting rail 604 which slides into the corresponding trapezoidal slot 407 of the FLS housing 400. The mounting block 600 is positioned so that the mounting block tab 602 aligns with an appropriate vertical mounting indentation 408 for a desired height. The FLS housing 400 with the mounting block 600 is inserted in the drain pan 124 such that the mounting block 600 rests on the top of the drain pan side wall. The FLS housing 400 is then secured to the drain pan 124 by inserting a screw through hole 606 and tightening.

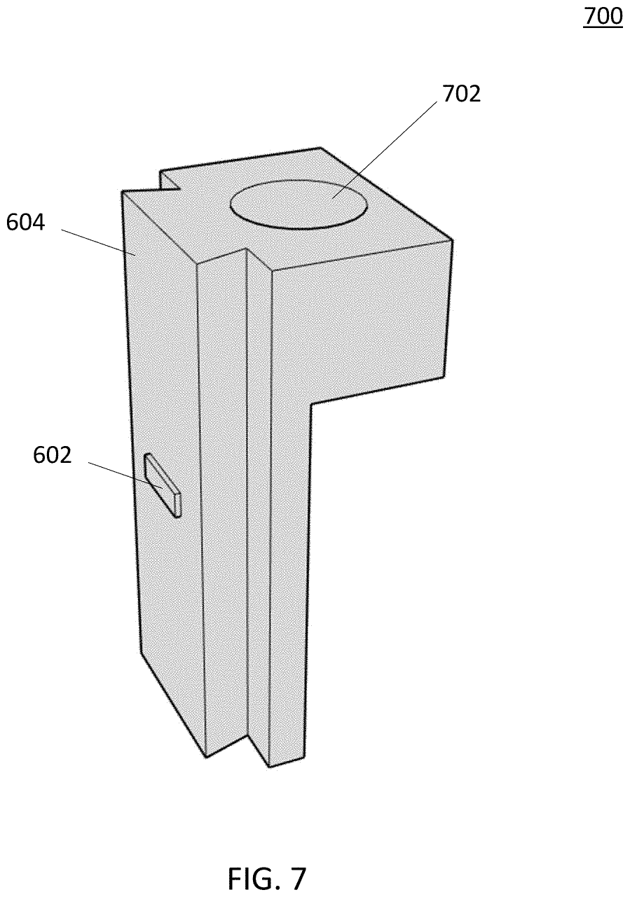

FIG. 7 illustrates a mounting block 700 with a magnetic mounting mechanism. The mounting block 700 also has a trapezoidal mounting rail 604 which slides into the corresponding trapezoidal slot 407 of the FLS housing 400. The mounting block 700 is positioned so that the mounting block tab 602 aligns with an appropriate vertical mounting indentation 408 for a desired height. The FLS housing 400 with the mounting block 700 is inserted into a metallic drain pan 124 and secured by a magnet 702 located at the top portion of the mounting block 700. Alternatively, a plastic drain pan 124 could be used and an opposing magnet placed on the outside of the pan sandwiches the pan between the two magnets.

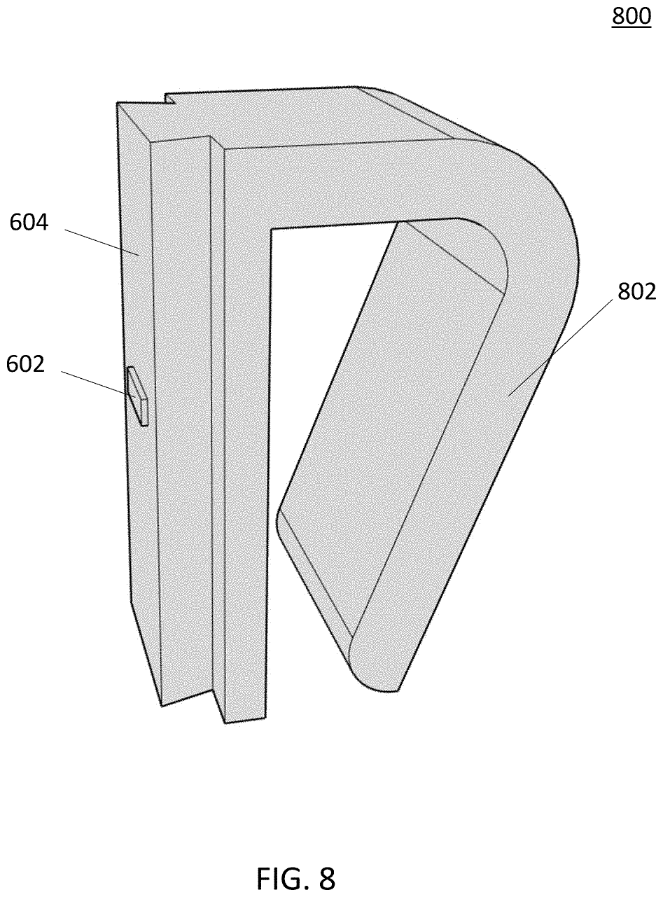

FIG. 8 illustrates a mounting block 800 with a spring mounting mechanism. Mounting block 800 has a similar mounting scheme to the FLS housing 400 as mounting blocks 600 and 700 as mounting block 800 also has a trapezoidal mounting rail 604 which slides into the corresponding trapezoidal slot 407 of the FLS housing 400 and the mounting block tab 602 aligns with an appropriate vertical mounting indentation 408. However, mounting block 800 is secured to the side wall of the drain pan 124 by a levered arm mechanism 802.

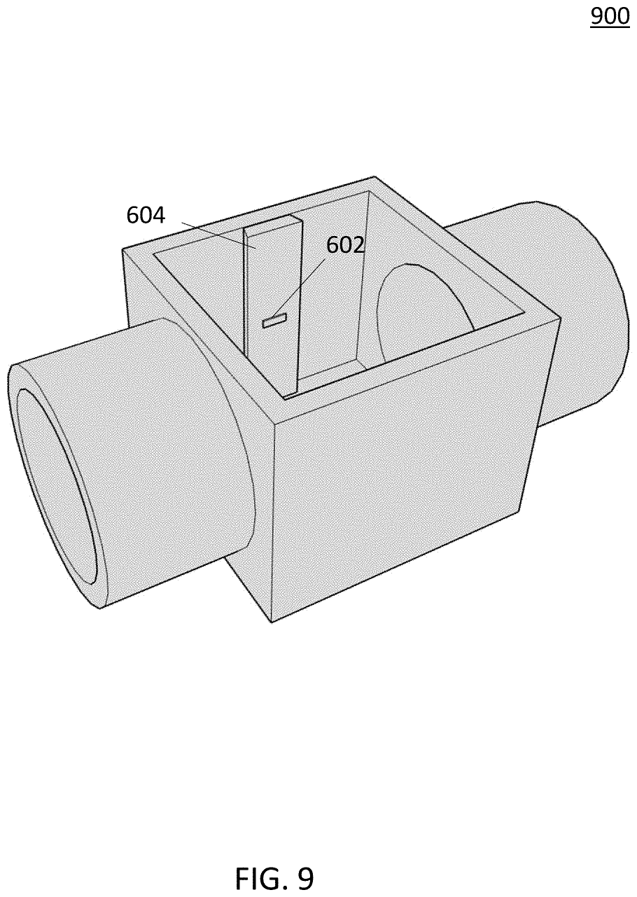

FIG. 9 illustrates a mounting block 900 that mounts the FLS housing 400 in an alternate position. Mounting block 900 connects the FLS housing 400 inside the primary condensate drain line instead of the drain pan 124 using a similar mounting scheme (i.e. a trapezoidal mounting rail 604 which slides into the corresponding trapezoidal slot 407 of the FLS housing 400 and a mounting block tab 602 that aligns with an appropriate vertical mounting indentation 408). In this case, wires attached to the FLS 128 are routed to the ECU 130 through a grommet in the cover (not shown) that covers the rectangular opening. In one embodiment, the cover itself may have the ECU 130 and/or the FLS 128 built-in such that the entire assembly is enclosed within the cover or the FLS 128 connected to the ECU 130 via a short cable.

Although the FLS 128 is shown above as encasing all sensors/sensor probes within a single housing, alternative embodiments may comprise a plurality of sensors or switches placed independently within the drainage system. The FLS 128 may also incorporate a float switch designed to turn off the system when the fluid level becomes critical.

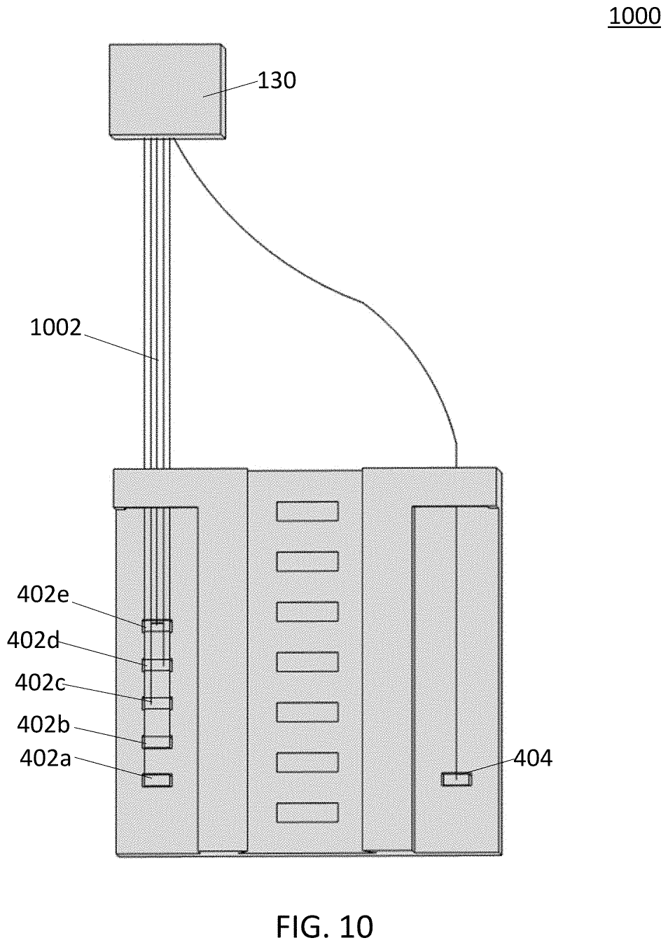

Turning now to FIG. 10, a wiring diagram 1000 is provided which illustrates how the FLS 128 is connected to the ECU 130. Each sensor/sensor pin located in slots 402 of the FLS housing 400 and the power supplied at slot 404 is wired to an input pin of the ECU 130 through a wiring harness 1002. The connections may either be hard-wired or connected using connectors. The ECU 130 is typically mounted to a side of the air handler 114 with sheet metal screws or double-sided adhesive tape. It should be noted that the ECU 130 and the FLS 128 of FIG. 10 are not drawn to scale.

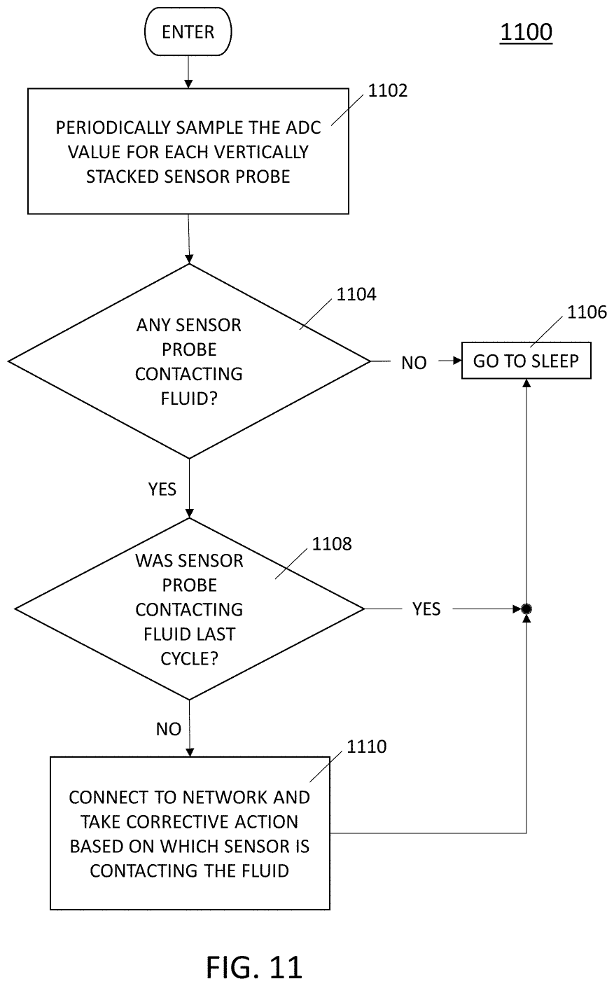

FIG. 11 provides a simpler operational flow diagram 1100 that describes the steps for a method of detecting and correcting condensation line blockages in accordance with one embodiment of the present invention. Beginning at step 1102, the ECU 130 periodically samples the values returned by the ADC for each vertically stacked sensor probe. Alternatively, the ECU 130 may sample the continuity between the electrical supply conductor and each sensor probe. A completed circuit between the supply conductor and the sensor probe, at step 1104, or an appropriate ADC value, indicates that the sensor probe is contacting the fluid in the drain pan 124. If this sensor probe was contacting the water during the last check, at step 1106, it is likely that the sensor probe contacting the fluid is a new event, potentially requiring corrective action. In which case, the ECU's processor 202 connects to a network, at step 1108, and takes any configured corrective action based on which sensor is contacting the fluid. Actions include, but are not limited to texting/SMS messaging, push notifications, email notifications, disabling connected equipment and attempting clear a condensation drain line blockage.

Returning to decision blocks 1104 and 1106, if there is no completed circuit between the supply conductor and any sensor probe, or if the sensor probe was already contacting the fluid when last checked, the ECU processor 202 returns to sleep, at step 1110, to conserve electrical power. This action is to avoid repeatedly taking corrective action. A configurable corrective action delay is built into the program which will repeat any corrective action taken if the system is ignored.

The present invention could be used to alert interested parties to more generic fluid level deviations in storage tanks or the like. These same concepts could apply to any fluid-level-sensing application where the owner/operator wishes to receive notifications in the event that the fluid level reaches an unacceptable range. For example, the present invention could also be used to monitor rain water that is stored in tanks. The software parameters could be adapted and the fluid level sensor changed to sense the level of a wide-variety of fluids and for providing notification capabilities in those settings. Some examples include: switching to a simple on/off switch to simply detect the presence of a fluid (such as water on a horizontal surface where none is expected); and immersing the FLS 128 in a tank to alert a remote operator when the fluid level is low.

### Non-Limiting Embodiments

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”,” “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer maybe connected to the user's computer through any type of network, including a local area network (LAN), wireless LAN (WLAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of detecting and resolving condensate line blockages comprising:
attaching a plurality of sensor probes to a drain system of a heating, ventilation and air conditioning (HVAC) system such that each probe detects a different level of fluid;
determining whether a sensor probe of the plurality of sensor probes is contacting fluid;
responsive to determining that the sensor probe is contacting fluid, initiating an action of a hierarchy of actions, wherein each action is associated with one of the sensor probes of the plurality of sensor probes; and
repeating the determining and initiating steps for each sensor probe of the plurality of sensor probes until all actions in the hierarchy of actions have been initiated sequentially.

2. The method of claim 1, wherein the hierarchy of actions comprises at least two of:
activating a cleaning solution dispenser;
altering an amount of cleaning solution dispensed;
activating an air pressure system to flush a condensate line;
sending a notification to a user informing of a condensate line blockage;
activating a backup HVAC system; and
disabling the HVAC system.

3. The method of claim 2, wherein the user is notified via one of: email, text messaging, push notifications, and a phone call.

4. The method of claim 2, wherein the user is one of an HVAC owner, a service technician, a property management software package and a maintenance company.

5. The method of claim 1, wherein the hierarchy of actions comprises sending a notification to a user informing of a condensate line blockage.

6. The method of claim 1, further comprising:
determining that a sensor probe previously contacting the fluid is no longer contacting the fluid; and
toggling off the action associated with the sensor probe previously contacting the fluid.

7. The method of claim 1, wherein each sensor probe of the plurality of sensor probes employs at least one of a solid-state device, a float switch-triggered potentiometer and an ultrasonic sensor.

8. A fluid level sensor for use in detecting and resolving condensate line blockages in a drainage system, the fluid level sensor comprising:
a housing;
a mounting block slidingly attached to the housing for mounting the fluid level sensor to a draining system; and
a plurality of sensor probes arranged in the housing such that each probe is configured to detect a different level of fluid when the housing is attached to the draining system.

9. The fluid level sensor of claim 8, wherein the draining system comprises a drain pan, the mounting block attaches to the drain pan via a tightening screw mechanism.

10. The fluid level sensor of claim 8, wherein the draining system comprises a drain pan, the mounting block attaches to the drain pan via a magnetic mechanism.

11. The fluid level sensor of claim 8, wherein the draining system comprises a drain pan, the mounting block attaches to the drain pan via a spring mechanism.

12. The fluid level sensor of claim 8, wherein the draining system comprises a condensate line, the mounting block is built into the condensate line.

13. A heating, ventilation and air conditioning (HVAC) system comprising:
a condensate resolving system for detecting and resolving condensate line blockages, the condensate resolving system comprising:
a draining system having at least one of a drain pan and a condensate line; and
a fluid level sensor comprising a plurality of sensor probes arranged such that each probe is configured to detect a different level of fluid when the fluid level sensor is attached to the draining system; and
an electronic control unit coupled to the condensate resolving system, the electronic control unit configured to:
determine whether a sensor probe of the plurality of sensor probes is contacting fluid; and
responsive to determining that the sensor probe is contacting fluid, initiate an action of a hierarchy of actions, wherein each action is associated with one of the sensor probes of the plurality of sensor probes.

14. The HVAC system of claim 13, further comprising:
an outdoor unit for changing phase of a refrigerant; and
an air handler coupled to the outdoor unit for circulating cooled air.

15. The HVAC system of claim 13, wherein the condensate resolving system further comprises a cleaning solution dispenser.

16. The HVAC system of claim 13, wherein the condensate resolving system further comprises an air pressure system.

17. The HVAC system of claim 13, wherein the hierarchy of actions comprise at least two of:
activating a cleaning solution dispenser;
altering an amount of cleaning solution dispensed;
activating an air pressure system to flush a condensate line;
sending a notification to a user informing of a condensate line blockage;
activating a backup HVAC system; and
disabling the HVAC system.

18. The HVAC system of claim 13, wherein the electronic controller further repeats the determining and initiating steps for each sensor probe of the plurality of sensor probes until all actions in the hierarchy of actions have been initiated sequentially.

19. The HVAC system of claim 13, wherein the electronic controller further:
determines that a sensor probe previously contacting the fluid is no longer contacting the fluid; and
toggles off the action associated with the sensor probe previously contacting the fluid.

20. The HVAC system of claim 13, wherein the fluid level sensor comprises:
a housing;
a mounting block slidingly attached to the housing for mounting the fluid level sensor to an HVAC draining system; and
a plurality of sensor probes arranged in the housing such that each probe is configured to detect a different level of fluid when the housing is attached to the draining system.

21. The HVAC system of claim 13, further comprising a network connection for sending a notification to a user informing of a condensate line blockage.
